(19) United States
(12) Patent Application Publication
(10) Pub. No.: US 2022/0170808 A1
(43) Pub. Date: Jun. 2, 2022

(54) PRESSURE SENSOR AND METHOD OF MANUFACTURING THE SAME

(71) Applicant: FATRI UNITED TESTING & CONTROL (QUANZHOU) TECHNOLOGIES CO., LTD., Quanzhou, Fujian (CN)

(72) Inventor: Yongzhong NIE, Xiamen, Fujian (CN)

(73) Assignee: FATRI UNITED TESTING & CONTROL (QUANZHOU) TECHNOLOGIES CO., LTD., Quanzhou, Fujian (CN)

(21) Appl. No.: 17/598,341

(22) PCT Filed: Mar. 24, 2020
(86) PCT No.: PCT/CN2020/080926

§ 371 Date: Sep. 27, 2021

(30) Foreign Application Priority Data
Mar. 27, 2019 (CN) 201910237241.0

(51) Int. Cl. G01L 9/12

(52) U.S. Cl. CPC G01L 9/12

(57) ABSTRACT

The present application provides a pressure sensor including: an upper cover plate having a first cover plate surface, wherein the upper cover plate has a cover plate through hole formed on the first cover plate surface; a pressure-sensitive film having a first pressure-sensitive surface and a second pressure-sensitive surface opposite to each other, wherein the first pressure-sensitive surface is attached to the first cover plate surface, a first electrode is formed on the second pressure-sensitive surface, and at least a portion of the first electrode corresponds to the cover plate through hole; and a substrate having a first surface joined to the second pressure-sensitive surface, wherein a concave cavity is formed on the first surface at a position corresponding to the cover plate through hole, a second electrode is formed at a wall portion of the concave cavity, and the first and second electrodes constitute two electrodes of a capacitor.

### CROSS-REFERENCE TO RELATED APPLICATIONS

The present application is a National Stage of International Application No. PCT/CN2020/080926, filed on Mar. 24, 2020, which claims priority to Chinese Patent Application No. 201910237241.0 filed on Mar. 27, 2019, titled “PRESSURE SENSOR AND METHOD OF MANUFACTURING THE SAME”, both of the applications are incorporated herein by reference in its entireties.

### TECHNICAL FIELD

The present application relates to the technical field of microelectronic mechanical systems, and in particular, to a pressure sensor and a method of manufacturing the same.

### BACKGROUND

Pressure sensors are widely used in the measurement of pressure parameters in various fields such as national defense, aerospace, industrial production and automatic control, especially in ultra-high temperature environments, for measuring a pressure of a boiler, a pipeline, a high-temperature reaction vessel, an oil well and an engine inner cavity, and measuring a pressure on an outer surface of various weapon engines and spacecraft, for example.

However, in the prior art, pressure sensors have large size and poor media compatibility.

Therefore, there is an urgent need for a new pressure sensor.

### SUMMARY

The embodiments of the present application provide a pressure sensor.

According to an aspect of the embodiments of the present application, there is provided a pressure sensor, including: an upper cover plate having a first cover plate surface, wherein the upper cover plate has a cover plate through hole formed on the first cover plate surface; a pressure-sensitive film having a first pressure-sensitive surface and a second pressure-sensitive surface opposite to each other, wherein the first pressure-sensitive surface is attached to the first cover plate surface, a first electrode is formed on the second pressure-sensitive surface, and at least a portion of the first electrode corresponds to the cover plate through hole; and a substrate having a first surface joined to the second pressure-sensitive surface, wherein a concave cavity is formed on the first surface at a position corresponding to the cover plate through hole, a second electrode is formed at a wall portion of the concave cavity, and the first electrode and the second electrode constitute two electrodes of a capacitor.

According to an aspect of the present application, the substrate has a first substrate through hole and a second substrate through hole formed on the first surface on a peripheral side of the concave cavity, the first substrate through hole and the second substrate through hole respectively have a first lead electrode and a second lead electrode at a junction of the first surface and the second pressure-sensitive surface, the first lead electrode is electrically connected to one of the first electrode and the second electrode, and the second lead electrode is electrically connected to the other of the first electrode and the second electrode.

According to an aspect of the present application, the first surface and the second pressure-sensitive surface are joined by an insulating layer.

According to an aspect of the present application, the first electrode is between the insulating layer and the second pressure-sensitive surface, and the second lead electrode is between the insulating layer and the second pressure-sensitive surface and is electrically connected to the first electrode.

According to an aspect of the present application, the first lead electrode is between the insulating layer and the first surface, and is electrically connected to the second electrode.

According to an aspect of the present application, the upper cover plate and the substrate have a same thickness.

According to an aspect of the present application, a contour of the cover plate through hole projected on the first pressure-sensitive surface is consistent with and corresponds to a contour of the concave cavity projected on the second pressure-sensitive surface.

According to an aspect of the present application, a material of the upper cover plate, the pressure-sensitive film and/or the substrate is sapphire.

According to another aspect of the embodiments of the present application, there is provided a method of manufacturing a pressure sensor, including the following steps: providing an upper cover plate having a first cover plate surface, wherein the upper cover plate has a cover plate through hole formed on the first cover plate surface; providing a pressure-sensitive film having a first pressure-sensitive surface and a second pressure-sensitive surface opposite to each other, wherein the first pressure-sensitive surface is attached to the first cover plate surface, a first electrode is formed on the second pressure-sensitive surface, and at least a portion of the first electrode corresponds to the cover plate through hole; providing a substrate having a first surface joined to the second pressure-sensitive surface, wherein a concave cavity is formed on the first surface at a position corresponding to the cover plate through hole, a second electrode is formed at a wall portion of the concave cavity, and the first electrode and the second electrode constitute two electrodes of a capacitor; and bonding the upper cover plate and the pressure-sensitive film, and the pressure-sensitive film and the substrate respectively through a bonding process, and then dicing to obtain the pressure sensor.

According to another aspect of the present application, the step of providing a pressure-sensitive film includes: depositing and etching a metal layer on a surface of the pressure-sensitive film to form a first electrode, a second lead electrode, and a lead therebetween; depositing an insulating layer on a surface of the pressure-sensitive film with the first electrode and the second lead electrode, and removing the insulating layer on the surface at the second lead electrode; and forming a first lead electrode on a surface of the insulating layer; and the step of providing a substrate includes: depositing and etching a metal layer on a surface of the substrate with the concave cavity to form a second electrode, a lead electrode ring, and a lead therebetween; and depositing an insulating layer on a surface of the substrate with the second electrode and the lead electrode ring, and removing the insulating layer on the surface at the lead electrode ring.

### BRIEF DESCRIPTION OF THE DRAWINGS

Features, advantages, and technical effects of exemplary embodiments of the present application will be described below with reference to the drawings.

FIG. 1 is a three-dimensional perspective view of a pressure sensor according to an embodiment of the present application;

FIG. 2 is a schematic structural diagram of a pressure sensor according to an embodiment of the present application;

FIG. 3 is a top view of an upper cover plate of a pressure sensor according to an embodiment of the present application;

FIG. 4 is a cross-sectional view of an upper cover plate of a pressure sensor along a line 11-11 in FIG. 3 according to an embodiment of the present application;

FIG. 5 is a bottom view of a pressure-sensitive film of a pressure sensor according to an embodiment of the present application;

FIG. 6 is a cross-sectional view of a pressure-sensitive film of a pressure sensor along a line 21-21 in FIG. 5 according to an embodiment of the present application;

FIG. 7 is a top view of a substrate of a pressure sensor according to an embodiment of the present application;

FIG. 8 is a cross-sectional view of a substrate of a pressure sensor along a line 31-31 in FIG. 7 according to an embodiment of the present application;

FIG. 9 is a flowchart of a method of manufacturing a pressure sensor according to an embodiment of the present application.

In the drawings, the drawings are not drawn to an actual scale.

### DESCRIPTION OF REFERENCE NUMERALS

10—upper cover plate; 101—first sapphire wafer; 102—cover plate through hole; 103—first cover plate surface; 20—pressure-sensitive film; 201—second sapphire wafer; 202—first electrode; 203—first lead electrode; 204—first pressure-sensitive surface; 205—second pressure-sensitive surface; 206—second lead electrode; 30—substrate; 301—third sapphire wafer; 303—concave cavity; 304—second electrode; 305—first surface; 306—first substrate through hole; 307—second substrate through hole; 401—insulating layer.

### DETAILED DESCRIPTION

The implementation of the present application will be described in further detail below in conjunction with the drawings and embodiments. The detailed description of the following embodiments and drawings are used to exemplarily illustrate the principle of the present application, but cannot be used to limit the scope of the present application, that is, the present application is not limited to the described embodiments.

The features and exemplary embodiments of various aspects of the present application will be described in detail below. In the following detailed description, many specific details are set forth in order to provide a comprehensive understanding of the present application. However, it is obvious to those skilled in the art that the present application can be implemented without some of these specific details. The following description of the embodiments is only to provide a better understanding of the present application by showing examples of the present application. In the drawings and the following description, at least part of well-known structures and technologies are not shown in order to avoid unnecessary blurring of the present application; and, for clarity, sizes of some structures may be exaggerated. In addition, the features, structures or characteristics described below may be combined in one or more embodiments in any suitable manner.

Orientation words appearing in the following description are all directions shown in the figures, and do not limit the specific structure of the embodiments of the present application. In the description of the present application, it should also be noted that, unless otherwise clearly specified and limited, the terms “installation” and “connection” should be understood in a broad sense, for example, it may refer to a fixed connection or a detachable connection, or an integral connection; it may refer to a direct connection or an indirect connection. For those of ordinary skill in the art, the specific meaning of the above-mentioned terms in the present application can be understood according to specific circumstances.

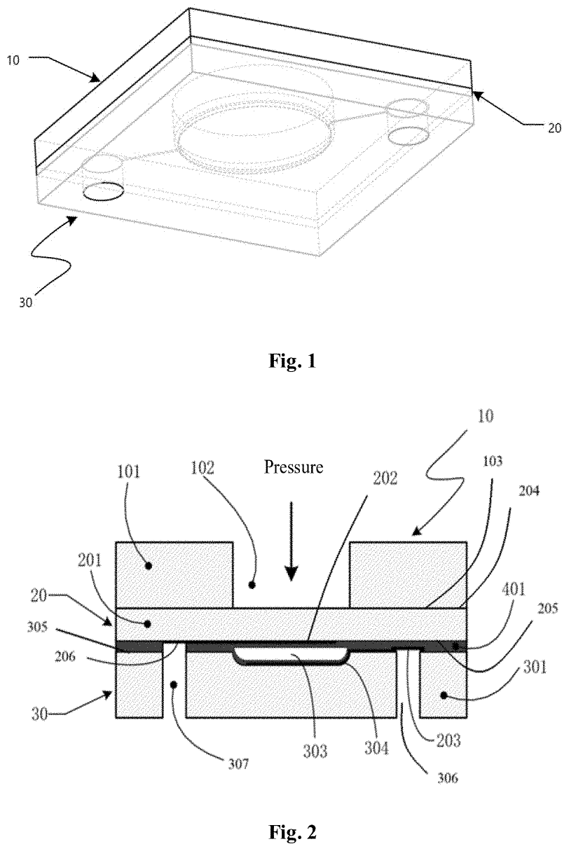

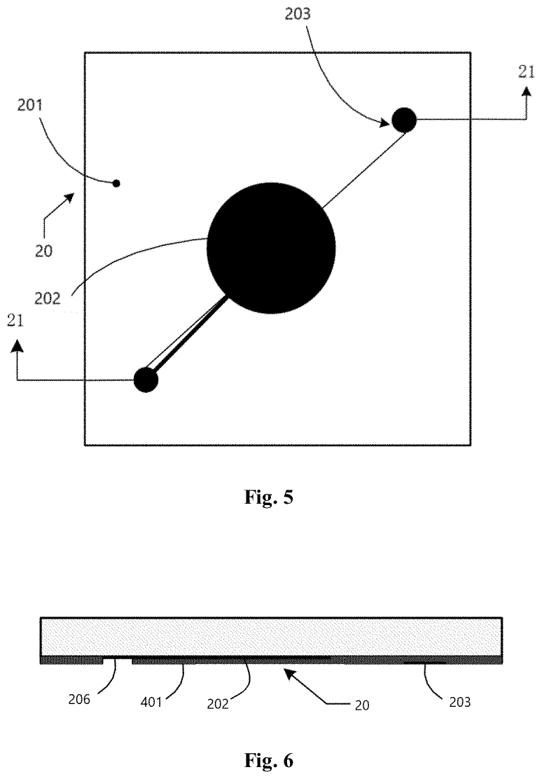

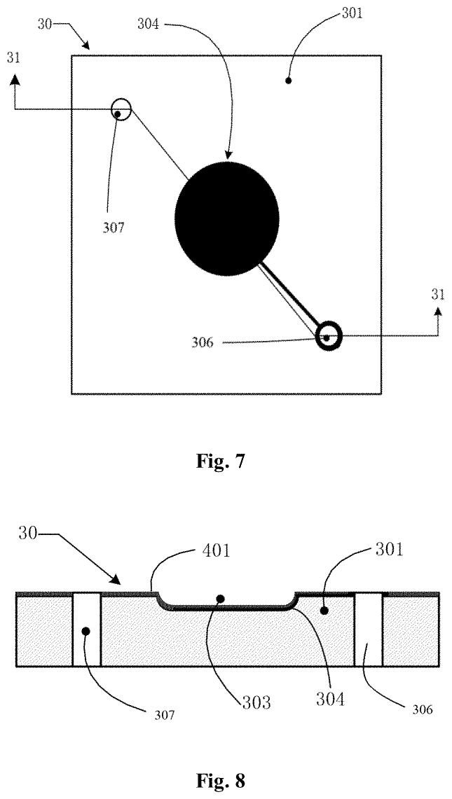

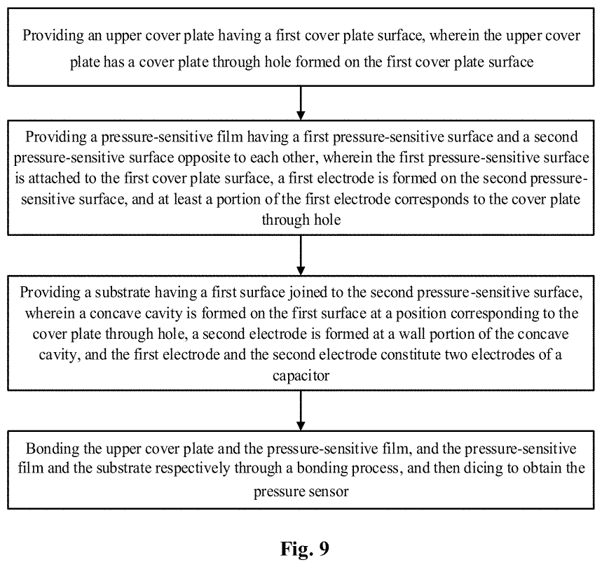

In order to better understand the present application, a pressure sensor according to the embodiments of the present application will be described in detail below with reference to FIGS. 1 to 8.

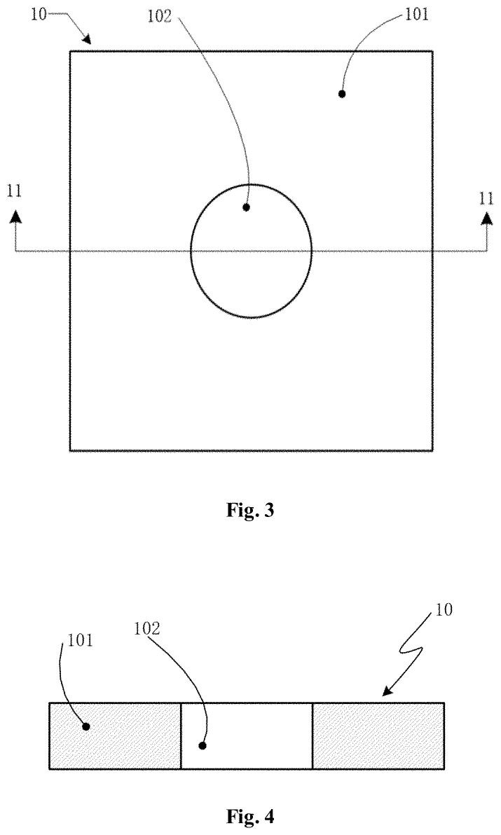

Referring to FIGS. 1-2 together, in which FIG. 1 is a three-dimensional perspective view of a pressure sensor according to an embodiment of the present application, and FIG. 2 is a schematic structural diagram of a pressure sensor according to an embodiment of the present application. The pressure sensor provided by the embodiments of the present application includes an upper cover plate 10, a pressure-sensitive film 20 and a substrate 30. As shown in FIGS. 3-4, the upper cover plate 10 has a first cover plate surface 103, wherein the upper cover plate 10 has a cover plate through hole 102 formed on the first cover plate surface 103. The pressure-sensitive film 20 has a first pressure-sensitive surface 204 and a second pressure-sensitive surface 205 opposite to each other. The first pressure-sensitive surface 204 is attached to the first cover plate surface 103, wherein a first electrode 202 is formed on the second pressure-sensitive surface 205, and at least a portion of the first electrode 202 corresponds to the cover plate through hole 102. The substrate 30 has a first surface 305 joined to the second pressure-sensitive surface 205, wherein a concave cavity 303 is formed on the first surface 305 at a position corresponding to the cover plate through hole 102, a second electrode 304 is formed at a wall portion of the concave cavity 303, and the first electrode 202 and the second electrode 304 constitute two electrodes of a capacitor. The first electrode 202 and the second electrode 304 are hermetically arranged between the pressure-sensitive film 20 and the substrate 30. Preferably, materials of the pressure-sensitive film 20 and the substrate 30 are insulating materials. Preferably, the upper cover plate 10 is made of the same insulating material as the pressure-sensitive film 20 and the substrate 30.

Shapes of the upper cover plate 10, the pressure-sensitive film 20, and the substrate 30 are not limited. The shapes of the upper cover plate 10, the pressure-sensitive film 20, and the substrate 30 may be the same or different, and may be, for example, circles, rectangles, ellipses, squares or other shapes. Preferably, the shapes of the upper cover plate 10, the pressure-sensitive film 20 and the substrate 30 are the same, and are all squares. A shape of the cover plate through hole 102 is also not limited, and it may be cylindrical, forward cone, inverted cone, square cylinder, etc., preferably cylindrical and located in the center of the upper cover plate 10. The number of the cover plate through hole 102 is also not limited, and it may be one or more, preferably one.

It can be understood that a form of joining between the first pressure-sensitive surface 204 and the first cover plate surface 103, and between the first surface 305 and the second pressure-sensitive surface 205 may be bonding, attaching, welding, or using other connecting parts (such as a tenon-and-mortise structure) separately or cooperating with other connecting parts for fitting connection.

Specifically, the first electrode 202 is formed on the second pressure-sensitive surface 205 and at least partially corresponds to the cover plate through hole 102, that is, a projection of the first electrode 202 on the second pressure-sensitive surface 205 and the a projection of cover plate through hole 102 on the second pressure-sensitive surface 205 overlap. Preferably, the first electrode 202 completely corresponds to the cover plate through hole 102. In the above preferred embodiments, the cover plate through hole 102 is a cylindrical through hole, and then in a preferred embodiment, the first electrode 202 is circular.

The position of the concave cavity 303 arranged on the first surface 305 may completely or partially correspond to the position of the cover plate through hole 102, that is, a projection of the concave cavity 303 on the first surface 305 and a projection of the cover plate through hole 102 on the first surface 305 partially overlap or completely overlap, preferably completely overlap. In this way, the first electrode 202 is partially or completely within a range of the concave cavity 303. In the above preferred embodiments, the cover plate through hole 102 is a cylindrical through hole, and then in a preferred embodiment, the projection of the concave cavity 303 on the first surface 305 is circular, and a diameter of the concave cavity 303 is equal to a diameter of the cover plate through hole 102. The concave cavity 303 has a depth in a thickness direction of the substrate 30. The second electrode 304 and the first electrode 202 overlap in a lateral direction (refer to a direction shown in FIG. 2).

The first electrode 202 and the second electrode 304 constitute two electrodes of the capacitor. The concave cavity 303 is vacuumed to form a vacuum reference cavity, or optionally filled with insulating gas or partially provided with a solid insulating layer, so that the first electrode 202 and the second electrode 304 are insulated and isolated. When the pressure-sensitive film 20 is exposed to an external pressure at the cover plate through hole 102, the pressure-sensitive film 20 at the cover plate through hole 102 is deformed, which in turn causes a space of the capacitor formed by the first electrode 202 and the second electrode 304 to change and thus causes a capacitance value change. A lead pin may be set at the substrate 30, and a capacitance signal may be extracted to be demodulated through a capacitance demodulation circuit, and to finally obtain a pressure signal, so that the received pressure may be calculated based on the capacitance value change to realize the measurement of the pressure sensor.

In the embodiments of the present application, by arranging the concave cavity 303 between the pressure-sensitive film 20 and the substrate 30, and arranging an electrode on an opposite wall portion of the concave cavity 303 to constitute two electrodes of the capacitor for pressure sensing, since the upper cover plate 10, the pressure-sensitive film 20 and the substrate 30 are closely attached to each other, and an electrode is arranged on a corresponding surface, such a structure ensures that an electrical connection device is isolated from a pressure medium to be measured, which improves a media compatibility and an anti-electromagnetic interference ability of the sensor, and at the same time, an overall size of the pressure sensor can be reduced, thereby reducing an overall package size of the sensor, and being able to perform high-precision pressure measurement through the formed capacitor.

In some optional embodiments, as shown in FIGS. 2 and 5-8, the substrate 30 has a first substrate through hole 306 and a second substrate through hole 307 formed on the first surface 305 on a peripheral side of the concave cavity 303. The first substrate through hole 306 and the second substrate through hole 307 respectively have a first lead electrode 203 and a second lead electrode 206 at a junction of the first surface 305 and the second pressure-sensitive surface 205, the first lead electrode 203 is electrically connected to one of the first electrode 202 and the second electrodes 304, and the second lead electrode 206 is electrically connected to the other of the first electrode 202 and the second electrode 304.

Positions and shapes of the first substrate through hole 306 and the second substrate through hole 307 are not limited. The first substrate through hole 306 and the second substrate through hole 307 may be symmetrically arranged with respect to the concave cavity 303, or may be arranged at one side of the concave cavity 303. The shapes of the first substrate through hole 306 and the second substrate through hole 307 may be cylindrical, forward cone, inverted cone, square column, etc., preferably cylindrical.

Specifically, the first lead electrode 203 and the second lead electrode 206 may correspond to the first substrate through hole 306 and the second substrate through hole 307 respectively. Preferably, the first lead electrode 203 corresponds to the first substrate through hole 306, that is, is located above the first substrate through hole 306 and connected with the first substrate through hole 306, and the second lead electrode 206 corresponds to the second substrate through hole 307, that is, is located above the second substrate through hole 307 and connected with the second substrate through hole 307.

It can be understood that the first lead electrode 203 and the second lead electrode 206 may be integrally formed, that is, composed of a single conductive member, or may be formed by connecting a plurality of conductive members, for example, may be formed by stacking and connecting a conductive ring and a conductive sheet.

It can be understood that the substrate 30 may also be arranged with more than two substrate through holes, which falls within the protection scope of the present application.

In some optional embodiments, as shown in FIG. 2, the first surface 305 and the second pressure-sensitive surface 205 are joined by an insulating layer 401. The insulating layer 401 may be first attached to only one of the first surface 305 and the second pressure-sensitive surface 205, and then attached to the other of the first surface 305 and the second pressure-sensitive surface 205. Preferably, the insulating layer 401 is divided into two layers, which are respectively attached to the first surface 305 and the second pressure-sensitive surface 205, and then the two insulating layers 401 are attached to form an integral insulating layer 401. The insulating layer 401 separates the first electrode 202 and the second electrode 304, and optionally separates the first lead electrode 203 and the second lead electrode 206. Optionally, the first electrode 202 and the second electrode 304 are sealed in the insulating layer 401. Optionally, a lead between the first electrode 202 and the second electrode 304 and a lead between the first lead electrode 203 and the second lead electrode 206 are sealed in the insulating layer 401. The insulating layer 401 protects a high-temperature resistant electrode film composed of the first electrode 202, the second electrode 304, the first lead electrode 203, and the second lead electrode 206, and serves as a bonding layer between the pressure-sensitive film 20 and the substrate 30.

In some optional embodiments, the first electrode 202 is between the insulating layer 401 and the second pressure-sensitive surface 205, and the second lead electrode 206 is between the insulating layer 401 and the second pressure-sensitive surface 205 and is electrically connected to the first electrode 202. Optionally, the second lead electrode 206 and the first electrode 202 may be electrically connected by a lead arranged between the insulating layer 401 and the second pressure-sensitive surface 205.

In some optional embodiments, the first lead electrode 203 is between the insulating layer 401 and the first surface 305, and is electrically connected to the second electrode 304. Optionally, the first lead electrode 203 and the second electrode 304 may be electrically connected by a lead arranged between the insulating layer 401 and the first surface 305.

In some optional embodiments, the upper cover plate 10 and the substrate 30 have a same thickness. Such a setting (especially at a high temperature) can effectively reduce a thermal stress on the pressure-sensitive film 20 to reduce a pressure measurement error caused by the thermal stress. Through theoretical calculation and finite element simulation, the thermal stress of the pressure sensor with a symmetrical design of three-layer structure in the present application at a high temperature is only ¼ of that of other structures.

In some optional embodiments, a contour of the cover plate through hole 102 projected on the first pressure-sensitive surface 204 is consistent with and corresponds to a contour of the concave cavity 303 projected on the second pressure-sensitive surface 205.

In some optional embodiments, a material of the upper cover plate 10, the pressure-sensitive film 20 and/or the substrate 30 is sapphire. Preferably, materials of the upper cover plate 10, the pressure-sensitive film 20 and the substrate 30 are all sapphire. It can be understood that materials of the upper cover plate 10, the pressure-sensitive film 20 and the substrate 30 may not be limited to sapphire, and may also be other materials or material combinations that have similar or better performance than using sapphire as a pressure sensor. Sapphire material has good thermal, mechanical and electrical insulation properties at a high temperature, its melting point exceeds 2000° C., and its mechanical properties are good at 1500° C. The pressure sensor made of sapphire material in the embodiments of the present application has excellent insulation, realizes isolation between the medium and the electricity, and improves the environmental adaptability and anti-electromagnetic interference ability of the sensor. The pressure sensor made of sapphire material in the embodiments of the present application can perform undistorted measurement in a high temperature environment without separately arranging a heat sink, a water cooling or pressure pipe. Moreover, compared with an optical fiber F-P type pressure sensor, since a bulky light source module and optical signal demodulation module is not needed, a smaller size and higher accuracy can be achieved. Compared with a wireless LC resonant pressure sensor, since a thick film coil and capacitor electrode of the wireless LC resonant pressure sensor are placed outside an absolute pressure cavity and directly contact a measured medium, a conductive medium cannot be measured, therefore the environmental adaptability and the anti-electromagnetic interference capability are poor and a maximum operating temperature is low. The pressure sensor provided by the embodiments of the present application isolates the electrical connection device from the pressure medium to be measured, improves the media compatibility of the sensor, and at the same time, the overall size of the pressure sensor can be reduced, and thus the overall package size of the sensor can be reduced. A size of the pressure sensor provided by the embodiments of the present application can be reduced to less than 2 mm×2 mm, an operating temperature can be raised to above 1000° C., and the pressure sensor has good compatibility with pressure media, and can measure a conductive or non-conductive gas and hydraulic pressure medium at a high temperature.

In order to better understand the present application, a method of manufacturing a pressure sensor according to an embodiment of the present application will be described in detail below with reference to FIG. 9.

As shown in FIG. 9, a method of manufacturing a pressure sensor provided by the present application includes the following steps: providing an upper cover plate 10 having a first cover plate surface 103, wherein the upper cover plate 10 has a cover plate through hole 102 formed on the first cover plate surface 103; providing a pressure-sensitive film 20 having a first pressure-sensitive surface 204 and a second pressure-sensitive surface 205 opposite to each other, wherein the first pressure-sensitive surface 204 is attached to the first cover plate surface 103, a first electrode 202 is formed on the second pressure-sensitive surface 205, and at least a portion of the first electrode 202 corresponds to the cover plate through hole 102; providing a substrate 30 having a first surface 305 joined to the second pressure-sensitive surface 205, wherein a concave cavity 303 is formed on the first surface 305 at a position corresponding to the cover plate through hole 102, a second electrode 304 is formed at a wall portion of the concave cavity 303, and the first electrode 202 and the second electrode 304 constitute two electrodes of a capacitor; and bonding the upper cover plate 10 and the pressure-sensitive film 20, and the pressure-sensitive film 20 and the substrate 30 respectively through a bonding process, and then dicing to obtain the pressure sensor.

A processing method of the cover plate through hole 102 may be laser processing, wet etching or dry etching. The concave cavity 303 may be formed on the first surface 305 by using a dry etching or wet etching process. For the first electrode 202, for example, a high-temperature resistant electrode film is prepared on the second pressure-sensitive surface 205 through a thin film deposition process, and then photolithography patterning, wet etching or dry etching are used in sequence to make the first electrode 202. For the second electrode 304, for example, a high-temperature resistant electrode film is prepared on a wall portion of the concave cavity 303 through a film deposition process, and then photolithography patterning, wet etching, or dry etching are used in sequence to make the second electrode 304.

In the embodiments of the present application, by providing the upper cover plate 10, the pressure-sensitive film 20 and the substrate 30 provided with the concave cavity 303 arranged between the pressure-sensitive film 20 and the substrate 30, arranging an electrode on an opposite wall portion of the concave cavity 303 to constitute two electrodes of the capacitor, and bonding the pressure-sensitive film 20 and the substrate 30 through a bonding process, the package size and structure size of the pressure sensor can be reduced, while improving the media compatibility and providing high-precision pressure measurement.

In some optional embodiments, the step of providing the pressure-sensitive film 20 includes: depositing and etching a metal layer on a surface of the pressure-sensitive film 20 to form the first electrode 202, the second lead electrode 206, and a lead therebetween, wherein the metal layer may be a titanium nitride/ruthenium/titanium nitride (TiN/Ru/TiN) composite metal film, or may be other high-temperature resistant conductive metal films such as titanium nitride/platinum/titanium nitride (TiN/Pt/TiN); depositing an insulating layer on a surface of the pressure-sensitive film 20 with the first electrode 202 and the second lead electrode 206, and removing the insulating layer on the surface at the second lead electrode 206, wherein the insulating layer may be an aluminum oxide (Al₂O₃) film; and forming a first lead electrode 203 on a surface of the insulating layer, wherein the step of forming the first lead electrode 203 may be the same as the step of forming the second lead electrode 206, or a conductive wafer may be directly arranged to form the first lead electrode 203. Positions of the first lead electrode 203 and the second lead electrode 206 on the plane are staggered.

Optionally, the surface of the insulating layer of the pressure-sensitive film 20 is planarized through a chemical mechanical polishing process (CMP) to facilitate a bonding operation.

A titanium nitride/ruthenium/titanium nitride and aluminum oxide, or titanium nitride/platinum/titanium nitride and aluminum oxide composite film layer increases an adhesion between the film layer and the sapphire substrate, improves the temperature resistance of the electrodes, and may also be used as a bonding layer for sapphire wafers.

In some optional embodiments, the step of providing the substrate 30 includes: depositing and etching a metal layer on a surface of the substrate 30 with the concave cavity 303 and to form the second electrode 304, a lead electrode ring and a lead therebetween. The metal layer may be a titanium nitride/ruthenium/titanium nitride (TiN/Ru/TiN) composite metal film, or may be other high-temperature resistant conductive metal films such as titanium nitride/platinum/titanium nitride (TiN/Pt/TiN); and depositing an insulating layer on a surface of the substrate 30 with the second electrode 304 and the lead electrode ring, and removing the insulating layer on the surface at the lead electrode ring, wherein the insulating layer may be an aluminum oxide (Al₂O₃) film, and the insulating layer on the surface at the lead electrode ring may be removed through a photolithography and etching process.

A position of the lead electrode ring is: when the pressure-sensitive film 20 is attached to the substrate 30, the lead electrode ring on the substrate 30 and the first lead electrode 203 on the pressure-sensitive film 20 overlap each other correspondingly, and may form an electrical connection.

Optionally, a surface of the insulating layer of the substrate 30 is planarized through a chemical mechanical polishing process (CMP) to facilitate a bonding operation.

Optionally, a thickness of the pressure-sensitive film 20 is different based on different range settings of the pressure sensor. Therefore, after the pressure-sensitive film 20 is bonded to the substrate 30, the thickness of the pressure-sensitive film 20 may be thinned and polished based on actual needs, and after thinning and polishing, the pressure-sensitive film 20 is then bonded with the upper cover plate 10 to form a three-layer structure.

In another embodiment of the present application, a method of manufacturing a pressure sensor is provided, which includes the following steps:

S10: providing a first sapphire wafer 101, a second sapphire wafer 201, and a third sapphire wafer 301, wherein sizes of the above three sapphire wafers are not limited, and 4-inch sapphire wafers are selected as an example;

S20: providing, through a laser processing process, a cover plate through hole 102 on the first sapphire wafer 101 to form an upper cover plate 10, and providing a first substrate through hole 306 and a second substrate through hole 307 on the third sapphire wafer 301;

S30: providing a concave cavity 303 on the third sapphire wafer 301 through a wet etching process;

S40: providing an electrode layer and an insulating layer on a surface of the third sapphire wafer 301 with the concave cavity 303 to form a substrate 30;

S50: providing an electrode layer and an insulating layer on a surface of the second sapphire wafer 201 to form a pressure-sensitive film 20;

S60: bonding, through a bonding process, the upper cover plate 10 and the pressure-sensitive film 20, and the pressure-sensitive film 20 and the substrate 30 respectively;

S70: dicing to obtain the pressure sensor.

In some optional embodiments, the step S40 includes:

S41: depositing a titanium nitride/ruthenium/titanium nitride (TiN/Ru/TiN) composite metal film on a surface of the substrate 30 with the concave cavity 303 through a physical vapor deposition (PVD) process;

S42: etching, through a photolithography patterning and dry etching process, the titanium nitride/ruthenium/titanium nitride composite metal film to form a second electrode 304, a lead electrode ring, and a lead therebetween;

S43: depositing an aluminum oxide (Al₂O₃) film on a surface of the substrate 30 with the second electrode 304 and the lead electrode ring through a physical vapor deposition process;

S44: removing the aluminum oxide film on the surface at the lead electrode ring through a photolithography patterning and dry etching process.

In some optional embodiments, the step S50 includes:

S51: depositing a titanium nitride/ruthenium/titanium nitride composite metal film on a surface of the pressure-sensitive film 20 through a physical vapor deposition process;

S52: etching, through a photolithography patterning and dry etching process, the titanium nitride/ruthenium/titanium nitride composite metal film to form a first electrode 202, a second lead electrode 206, and a lead therebetween;

S53: depositing an aluminum oxide film on a surface of the pressure-sensitive film 20 with the first electrode 202 and the second lead electrode 206 through a physical vapor deposition process;

S54: removing the aluminum oxide film on the surface at the second lead electrode 206 through a photolithography patterning and dry etching process;

S55: forming a first lead electrode 203 on a surface of the aluminum oxide film.

In some optional embodiments, the step S60 includes:

S61: reducing, through a chemical mechanical polishing (CMP) process, a roughness of the aluminum oxide film of the pressure-sensitive film 20 and a roughness of the aluminum oxide film of the substrate 30 to less than 0.5 nm respectively;

S62: bonding the pressure-sensitive film 20 and the aluminum oxide film of the substrate 30 through an aluminum oxide direct bonding process, wherein a bonding area forms an insulating layer 401;

S63: thinning, through a sapphire thinning and polishing process, a side of the pressure-sensitive film 20 without the aluminum oxide film based on a required range;

S64: bonding, through a sapphire direct bonding process, the upper cover plate 10 to the side of the pressure-sensitive film 20 without the aluminum oxide film.

Although the present application has been described with reference to preferred embodiments, various modifications can be made to it without departing from the scope of the present application and components therein can be replaced with equivalents. In particular, as long as there is no structural conflict, various technical features mentioned in various embodiments can be combined in any manner. The present application is not limited to the specific embodiments disclosed herein, but includes all technical solutions falling within the scope of the claims.

1. A pressure sensor, comprising:
an upper cover plate having a first cover plate surface, wherein the upper cover plate has a cover plate through hole formed on the first cover plate surface;
a pressure-sensitive film having a first pressure-sensitive surface and a second pressure-sensitive surface opposite to each other, wherein the first pressure-sensitive surface is attached to the first cover plate surface, a first electrode is formed on the second pressure-sensitive surface, and at least a portion of the first electrode corresponds to the cover plate through hole; and
a substrate having a first surface joined to the second pressure-sensitive surface, wherein a concave cavity is formed on the first surface at a position corresponding to the cover plate through hole, a second electrode is formed at a wall portion of the concave cavity, and the first electrode and the second electrode constitute two electrodes of a capacitor.

2. The pressure sensor of claim 1, wherein the substrate has a first substrate through hole and a second substrate through hole formed on the first surface on a peripheral side of the concave cavity, the first substrate through hole and the second substrate through hole respectively have a first lead electrode and a second lead electrode at a junction of the first surface and the second pressure-sensitive surface, the first lead electrode is electrically connected to one of the first electrode and the second electrode, and the second lead electrode is electrically connected to the other of the first electrode and the second electrode.

3. The pressure sensor of claim 1, wherein the first surface and the second pressure-sensitive surface are joined by an insulating layer.

4. The pressure sensor of claim 3, wherein the first electrode is between the insulating layer and the second pressure-sensitive surface, and the second lead electrode is between the insulating layer and the second pressure-sensitive surface and is electrically connected to the first electrode.

5. The pressure sensor of claim 3, wherein the first lead electrode is between the insulating layer and the first surface, and is electrically connected to the second electrode.

6. The pressure sensor of claim 1, wherein the upper cover plate and the substrate have a same thickness.

7. The pressure sensor of claim 1, wherein a contour of the cover plate through hole projected on the first pressure-sensitive surface is consistent with and corresponds to a contour of the concave cavity projected on the second pressure-sensitive surface.

8. The pressure sensor of claim 1, wherein a material of the upper cover plate, the pressure-sensitive film and/or the substrate is sapphire.

9. A method of manufacturing a pressure sensor, comprising the following steps:
providing an upper cover plate having a first cover plate surface, wherein the upper cover plate has a cover plate through hole formed on the first cover plate surface;
providing a pressure-sensitive film having a first pressure-sensitive surface and a second pressure-sensitive surface opposite to each other, wherein the first pressure-sensitive surface is attached to the first cover plate surface, a first electrode is formed on the second pressure-sensitive surface, and at least a portion of the first electrode corresponds to the cover plate through hole;
providing a substrate having a first surface joined to the second pressure-sensitive surface, wherein a concave cavity is formed on the first surface at a position corresponding to the cover plate through hole, a second electrode is formed at a wall portion of the concave cavity, and the first electrode and the second electrode constitute two electrodes of a capacitor; and
bonding the upper cover plate and the pressure-sensitive film, and the pressure-sensitive film and the substrate respectively through a bonding process, and then dicing to obtain the pressure sensor.

10. The method of manufacturing a pressure sensor of claim 9, wherein:
the step of providing a pressure-sensitive film comprises:
depositing and etching a metal layer on a surface of the pressure-sensitive film to form a first electrode, a second lead electrode, and a lead therebetween;
depositing an insulating layer on a surface of the pressure-sensitive film with the first electrode and the second lead electrode, and removing the insulating layer on the surface at the second lead electrode; and
forming a first lead electrode on a surface of the insulating layer; and
the step of providing a substrate comprises:
depositing and etching a metal layer on a surface of the substrate with the concave cavity to form a second electrode, a lead electrode ring, and a lead therebetween; and
depositing an insulating layer on a surface of the substrate with the second electrode and the lead electrode ring, and removing the insulating layer on the surface at the lead electrode ring.
